(19) United States
(12) Patent Application Publication
(10) Pub. No.: US 2019/0158849 A1
(43) Pub. Date: May 23, 2019

(54) METHOD AND APPARATUS FOR DIGITAL IMAGE QUALITY EVALUTATION

(71) Applicant: Zhejiang University, Hangzhou, Zhejiang Province (CN)

(72) Inventors: Lu YU, Hangzhou, Zhejiang Province (CN); Yule SUN, Hangzhou, Zhejiang Province (CN); Ang LU, Hangzhou, Zhejiang Province (CN)

(21) Appl. No.: 16/099,491

(22) PCT Filed: May 5, 2017
(86) PCT No.: PCT/CN2017/083264

§ 371 Date: Nov. 7, 2018

(30) Foreign Application Priority Data
May 7, 2016 (CN) 2016103019530

(51) Int. Cl. H04N 19/154; H04N 19/597; H04N 17/00; G06T 7/00

(52) U.S. Cl. CPC H04N 19/154; H04N 19/597; G06T 2207/30168; G06T 7/0002; H04N 17/004

(57) ABSTRACT

This invention provides method and apparatus for quality evaluation of digital image to be used in the field of communication. The invention is used to tackle with the problem caused by the differences between the representation space of the digital image and the observation space. The digital image quality evaluation method calculates the objective quality of the digital image reflected in the observation space, while the calculation part is completed in the space to be evaluated. The digital image quality evaluation apparatus includes a distortion value generation module, a distortion value processing module, and a digital image quality evaluation module. The invention can provide a more accurate and fast objective quality calculation method in the observation space for the digital image in the space to be evaluated. The method of the invention is applied to digital image or digital sequence which can provide the accurate rate allocation scheme for the compression coding, and the coding performance can be greatly improved in the coding tool of digital image or digital video.

### TECHNICAL FIELD

This patent belongs to the field of communication technology, and more specifically speaking, it is a method for evaluating the quality of a digital image in the case where the representation space of digital images is different from corresponding observation space.

### BACKGROUND OF THE INVENTION

Essentially, digital image signal is a two-dimensional signal arranged in space. A window is utilized to collect pixel samples in the spatial domain to form a digital image. The images collected at different times are arranged in chronological order to form a moving digital image sequence. An important purpose of digital images is to be used for watching, and the objective quality evaluation of digital images affects the loss of compression, transmission and other process of digital images.

The role of the camera is to simulate the image observed by human eye in the corresponding position. The space of scene captured by camera is defined as observation space, which reflects the actual pictures captured by human eyes. But the space of observation space varies from its design to multi-camera system. Considering the convenience of signal processing, we usually project image expressed in the observation space to the representation space as the conversion to unify the signal format. Those images in the representation space are more convenient to be processed (the most common representation space is the two-dimensional plane).

For the conventional digital image, representation space is consistent with the observation space (the connection between the representation space and the presentation space can be established by affine transformation), meaning that the processing image is consistent with the observing image. Therefore, characteristics of the observation space need no extra processing when conventional digital images are processed. To evaluate the quality of a signal in the space to be evaluated, we need to specify a standard reference space to indicate the best signal. Then signal quality, the distortion of signal in the space to be evaluated, can be evaluated by comparing the difference between the signal in the representation space and the reference space.

For example, the objective quality of the basic processing unit A₁ in the digital image can be evaluated by the most popular objective quality evaluation method. As a distortion calculation method, it is based on the following assumptions that A₁ is corresponding to original reference Aₒ, then the objective quality (distortion), can be expressed as a difference function [symbol] =Diff(A₁, Aₒ) per pixels belonging to A₁ and Aₒ. Where the difference function can be summing the absolute value of differences of each pixel belonging to A₁ and Aₒ, or may be the mean squared error of A₁ and Aₒ, or the peak signal-to-noise ratio of A₁ and Aₒ. The difference function is not limited to those mentioned above.

With the development of digital image and display technology, the digital image space we have observed is no longer limited to two-dimensional plane any more, Naked-eye 3D technology, panoramic digital image technology, 360-degree virtual reality technology and many other innovations have created various modes of presentation. In order to inherit the original digital image processing technology and simplify the difficulty to deal with digital image signal in high-dimensional space, usually high-dimensional signal will be converted to 2D plane through the projection transformation so that the signal can be processed in an easier way. (For example, video coding standard can only encode two-dimensional content for now. In order to cooperate with the current compression standard, a common operation is that project high-dimensional space to a two-dimensional plane, and then encode the two-dimensional content. During the process that images are mapped to the two-dimensional plane, areas at different positions of the two-dimensional images not only have corresponding relationship with images presented in high-dimensional space but also may have different degree of stretching. For example, current spherical video scene needs to be mapped to a rectangular area, a representation of the panorama image—equirectangular projection (ERP) format is one choice. For ERP format, however, stretching deformation of dipolar areas is much larger than the equator areas, while in the spherical observation space each direction is isotropic.

With the introduction of new digital image display and presentation technology, the relationship between the representation space and the observation space of digital image is no longer linear. For the new application scenario, to evaluate the quality of a digital image sequence is no longer simply accumulating the differences of signal units in the representation space. When it comes to the digital images for observation, we pay more attention to the quality of digital images in the observation space. Quality of digital images can only be accurately evaluated if differences of each pixel in digital images are processed in the observation space.

Current technology requires specification of the type of observation space, and then uniform sampling will be operated in the observation space. Furthermore, locate corresponding points in the observation space of each pixel in the reference image and the image to be evaluated. Eventually, difference of pixels in the reference image and the image to be evaluated will be calculated based on those uniformly distribution points in the observation space. This method has following shortcomings: a) uniform sampling of the observation space is an extremely difficult problem, such as the spherical uniform sampling, usually the best we can get is approximate solution, and the calculation is complex; interpolation and other operations will be involved during the conversion process, which will introduce some error, unless interpolation method with better performance but much longer processing time is applied. The number of characterization pixels of the processing unit in the space to be evaluated can be different from reference space, meaning that it is difficult to determine the number of uniform points in the observation space.

### SUMMARY OF THE INVENTION

To solve the technical problem mentioned above, the patent proposes an evaluation scheme for digital image quality based on an observation space. In this scheme, the relationship between the representation space and the observation space of the digital image cannot be represented by affine transformation.

### Method and Apparatus for Digital Image Quality Evaluation

The first technical solution of the present invention is to provide a digital image quality evaluation method for measuring the quality of a digital image in the space to be evaluated. This method comprising: summing the absolute value of the pixel values of the respective pixel group of the digital images in the space to be evaluated and the digital images in the reference space pixel by pixel to obtain the distortion values. The described pixel group comprises at least one of the following expressions:

a) one pixel;

b) one set of spatially continuous pixels in the space;

c) one set of temporally discontinuous pixels in the space.

The described method to obtain the absolute value of the digital images comprises at least one of the following processing methods:

a) converting the digital image in the space to be evaluated into the same space as the reference space, after calculating each difference of each pixel value between the corresponding pixel in the pixel group of the digital image in the space to be evaluated and the corresponding pixel in the pixel group of the digital image in the reference space, summing the absolute value of differences calculated before;

b) converting the digital image in the reference space into the same space as the space to be converted, after calculating each difference of each pixel value between the corresponding pixel in the pixel group of the digital image in the converted reference space and the corresponding pixel in the pixel group of the digital image in the space to be evaluated, summing the absolute value of differences calculated before;

c) converting the digital image in the reference space and the digital image in the space to be evaluated into the same space which is different from the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;

d) in the case where the space to be evaluated is exactly same as the reference space, conversion is not necessary, after calculating each difference between the corresponding pixel value of the pixel group of the digital image in the space to be evaluated and the corresponding pixel value of the pixel group of the digital image in the reference space, summing the absolute value of differences calculated before.

The distortion values of the digital images in the space to be evaluated are processed according to the distribution of pixel groups in observation space. the method to process the distortion value of the digital images in the space to be evaluated according to the distribution of the pixel groups in observation space comprises at least one of the following processing methods:

a) projecting the relevant area corresponding to the pixel group of digital image in the space to be evaluated into the observation space and calculate the ratio of the corresponding area to the total area of the image in the observation space; calculating the result by multiplying the ratio and the distortion value;

b) projecting the relevant area corresponding to the pixel group of digital image in the space to be evaluated into the observation space corresponding to the pixel group of digital image in the reference space into the observation space and calculate the ratio of the corresponding area to the total area of the image in the observation space; calculating the result by multiplying the ratio and the distortion value.

The method to locate the relevant area corresponding to the pixel group comprises at least one of the following methods:

a) taking the area of three nearest pixel groups of this pixel group;

b) taking the area of four nearest pixel groups of the pixel group;

c) taking the area enclosed by three nearest pixel groups of the pixel group and the midpoints of these pixel groups;

d) taking the area enclosed by four nearest pixel groups of the pixel group and the midpoints of these pixel groups;

e) taking the area enclosed by the pixel group on each axis that does not exceed the unit distance between the pixels and the pixel group;

f) taking the area enclosed by the midpoint of the pixel group and the pixel group on each axis that does not exceed the unit distance between the pixels and the pixel group;

g) when the pixel group is one pixel, taking the area determined by the micro unit at the center point of the pixel.

The quality of the digital images in the space to be evaluated is measured by using the distortion value of the pixel groups of the entire digital image to be evaluated after the processing.

The second technical solution of the present invention is to provide a digital image quality evaluation apparatus for measuring the quality of a digital image in the space to be evaluated. This apparatus comprising: summing the absolute value of the pixel values of each pixel group of the digital image in the space to be evaluated and the digital image in the reference space pixel by pixel to obtain the distortion value. The described pixel group comprises at least one of the following expressions:

a) one pixel;

b) one set of spatially continuous pixels in the space;

c) one set of temporally discontinuous pixels in the space.

The input of the distortion generation module is the reference spatial digital image and the space to be evaluated and the output is distortion corresponding to the pixel group in the space to be evaluated. The method to obtain the absolute value of the digital image comprises at least one of the following processing methods:

a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;

b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;

c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;

d) in the case where the space to be evaluated is exactly same as the reference space, conversion is not necessary, after calculating each difference between the corresponding pixel value of the pixel group of the digital image in the space to be evaluated and the corresponding pixel value of the pixel group of the digital image in the reference space, summing the absolute value of differences calculated before.

A weighted distortion processing module processes the distortion value according to the distribution of the pixel group of the digital image in the space to be evaluated on the observation space, the input of which is the space to be evaluated and the output space is the corresponding weights of the pixel group in the space to be evaluated. The method to process the distortion value according to the distribution in the observation space of the pixel group of the digital image in the space to be evaluated comprises at least one of the following processing methods:

a) projecting the relevant area corresponding to the pixel group of digital image in the space to be evaluated into the observation space and calculate the ratio of the corresponding area to the total area of the image in the observation space; calculating the result by multiplying the ratio and the distortion value;

b) projecting the relevant area corresponding to the pixel group of digital image in the space to be evaluated into the observation space corresponding to the pixel group of digital image in the reference space into the observation space and calculate the ratio of the corresponding area to the total area of the image in the observation space; calculating the result by multiplying the ratio and the distortion value.

The method to locate the correlation area corresponding to the pixel group comprises at least one of the following methods:

a) taking the area of three nearest pixel groups of this pixel group;

b) taking the area of four nearest pixel groups of the pixel group;

c) taking the area enclosed by three nearest pixel groups of the pixel group and the midpoints of these pixel groups;

d) taking the area enclosed by four nearest pixel groups of the pixel group and the midpoints of these pixel groups;

e) taking the area enclosed by the pixel group on each axis that does not exceed the unit distance between the pixels and the pixel group;

f) taking the area enclosed by the midpoint of the pixel group and the pixel group on each axis that does not exceed the unit distance between the pixels and the pixel group;

g) when the pixel group is one pixel, taking the area determined by the micro unit at the center point of the pixel.

For the quality evaluation module, the processed distortion corresponding to the pixel group of the digital image of the entire image to be evaluated and the corresponding weights of the digital image are utilized to evaluate the quality of the digital image to be evaluated, the input of quality evaluation module is the corresponding weights of the pixel group and the distortion value corresponding to the pixel group in the space to be evaluated and output is the quality of the digital image in the observation space.

The third technical solution of the present invention is to provide a digital image quality evaluation method for measuring the quality of a digital image in the space to be evaluated. This method comprising: obtaining the distortion values of each pixel group in the digital image by using the pixel values of the respective pixel groups of the digital images in the space to be evaluated and reference space.

The method to obtain the distortion values of each pixel group in the digital image comprises at least one of the following processing methods:

a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;

b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;

c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;

d) in the case where the space to be evaluated is exactly the same as the reference space, conversion is not necessary; after calculating each difference between the corresponding pixel value of the pixel group of the digital image in the space to be evaluated and the corresponding pixel value of the pixel group of the digital image in the reference space, summing the absolute value of differences calculated before.

The distortion values of the pixel groups of the digital images in the space to be evaluated are processed according to the distribution in observation space. The method to process the distortion value of the pixel groups of the digital images in the space to be evaluated according to the distribution in observation space comprises at least one of the following processing methods:

a) projecting the relevant area corresponding to the pixel group of digital image in the space to be evaluated into the observation space and calculate the ratio of the corresponding area to the total area of the image in the observation space; calculating the result by multiplying the ratio and the distortion value, the result is the processed distortion value;

b) projecting the relevant area corresponding to the pixel group of digital image in the space to be evaluated into the observation space and calculate the stretching ratio of the pixel group of digital image in the space to be evaluated; calculating the result by multiplying the stretching ratio and the distortion value, the result is the processed distortion value.

The method to locate the relevant area corresponding to the pixel group comprises at least one of the following methods:

a) taking the area of three nearest pixel groups of this pixel group;

b) taking the area of four nearest pixel groups of the pixel group;

c) taking the area enclosed by three nearest pixel groups of the pixel group and the midpoints of these pixel groups;

d) taking the area enclosed by four nearest pixel groups of the pixel group and the midpoints of these pixel groups;

e) taking the area enclosed by the pixel group on each axis that does not exceed the unit distance between the pixels and the pixel group;

f) taking the area enclosed by the midpoint of the pixel group and the pixel group on each axis that does not exceed the unit distance between the pixels and the pixel group;

g) when the pixel group is one pixel, taking the area determined by the micro unit at the center point of the pixel.

The quality of the digital images in the space to be evaluated is measured by using the distortion value of the pixel group of the entire digital image to be evaluated after the processing.

The fourth technical solution of the present invention is to provide a digital image quality evaluation apparatus for measuring the quality of a digital image in the space to be evaluated. This apparatus comprising: the pixel values of each pixel group in the digital image to be evaluated is calculated pixel by pixel with the corresponding pixel values of the digital image in the reference space to obtain the distortion value, which is the distortion generation module; the input is the digital images in reference space and the space to be evaluated and the output is distortion values for the pixel group in the space to be evaluated.

The method to obtain the distortion value of the digital image in distortion generation module comprises at least one of the following processing methods:

a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;

b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;

c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;

d) in the case where the space to be evaluated is exactly the same as the reference space, conversion is not necessary; after calculating each difference between the corresponding pixel value of the pixel group of the digital image in the space to be evaluated and the corresponding pixel value of the pixel group of the digital image in the reference space, summing the absolute value of differences calculated before.

A weighted distortion processing module processes the distortion value of the pixel group of the digital image in the space to be evaluated according to the distribution in the observation space, the input of which are the distribution of pixel group in the digital image to be evaluated and the observation space and the output is the corresponding weights of the pixel group in the space to be evaluated. The method to obtain the result of quality evaluation in quality evaluation module comprises at least one of the following processing methods:

a) projecting the relevant area corresponding to the pixel group of digital image in the space to be evaluated into the observation space and calculate the ratio of the corresponding area to the total area of the image in the observation space; calculating the result by multiplying the ratio and the distortion value, the result is the processed distortion value;

b) projecting the relevant area corresponding to the pixel group of digital image in the space to be evaluated into the observation space and calculate the stretching ratio of the pixel group of digital image in the space to be evaluated; calculating the result by multiplying the stretching ratio and the distortion value, the result is the processed distortion value.

The method to locate the relevant area corresponding to the pixel group comprises at least one of the following methods:

a) taking the area of three nearest pixel groups of this pixel group;

b) taking the area of four nearest pixel groups of the pixel group;

c) taking the area enclosed by three nearest pixel groups of the pixel group and the midpoints of these pixel groups;

d) taking the area enclosed by four nearest pixel groups of the pixel group and the midpoints of these pixel groups;

e) taking the area enclosed by the pixel group on each axis that does not exceed the unit distance between the pixels and the pixel group;

f) taking the area enclosed by the midpoint of the pixel group and the pixel group on each axis that does not exceed the unit distance between the pixels and the pixel group;

g) when the pixel group is one pixel, taking the area determined by the micro unit at the center point of the pixel.

For the quality evaluation module, the processed distortion corresponding to the pixel group of the digital image of the entire image to be evaluated and the corresponding weights of the digital image are utilized to measure the quality of the digital image to be evaluated, input is the corresponding weights of the pixel group and the distortion value corresponding to the pixel group in the space to be evaluated and output is the quality of the digital image in the observation space.

Benefit of this invention is that the distribution of the corresponding processing unit in the observation space is introduced the evaluation of digital images quality in the representation space compared with the conventional technique. Compared with the prior methods, the problem caused by selection of points in observation space uniformly is avoided (uniform sampling on the sphere is an extremely difficult problem), which is converted to the problem of the area of the processing unit. The area can be calculated offline or online. What's more, this kind of design reduces the error introduced by the conversion between representation spaces. For the case where the representation space of the reference digital image Wᵣₑₚ and the representation space of the digital image to be evaluated Wₜ can be linearly represented, no conversion is required. But for the case where the representation space of the reference digital image Wᵣₑₚ and the representation space of the digital image to be evaluated Wₜ cannot be linearly represented, only one conversion is required. The conversion error is much smaller than the existing method (conversion between observation space of the digital image to be observed Wₒ and the representation space of the digital image to be evaluated Wₜ are required twice for every evaluation).

### BRIEF DESCRIPTION OF THE DRAWINGS

According to these figures, other features and advantages of the present invention will become more apparent from the following description of the selected embodiments as further introduction.

Drawings mentioned following provide a further understanding of the invention, which should also be treated as a part of this application, and the illustrative embodiments of the invention and its description are intended to account for the invention which will not construct limitations of the invention. For figures:

FIG. 1 is a definition of the latitude and longitude diagram with respect to the sphere used in embodiments of the present invention;

FIG. 2 is an illustration of the correspondence relationship of the latitude and longitude image to be evaluated and the sphere in the observation space in embodiments of the present invention;

FIG. 3 is an illustration of structural relationship of digital image quality evaluation apparatus of the present invention;

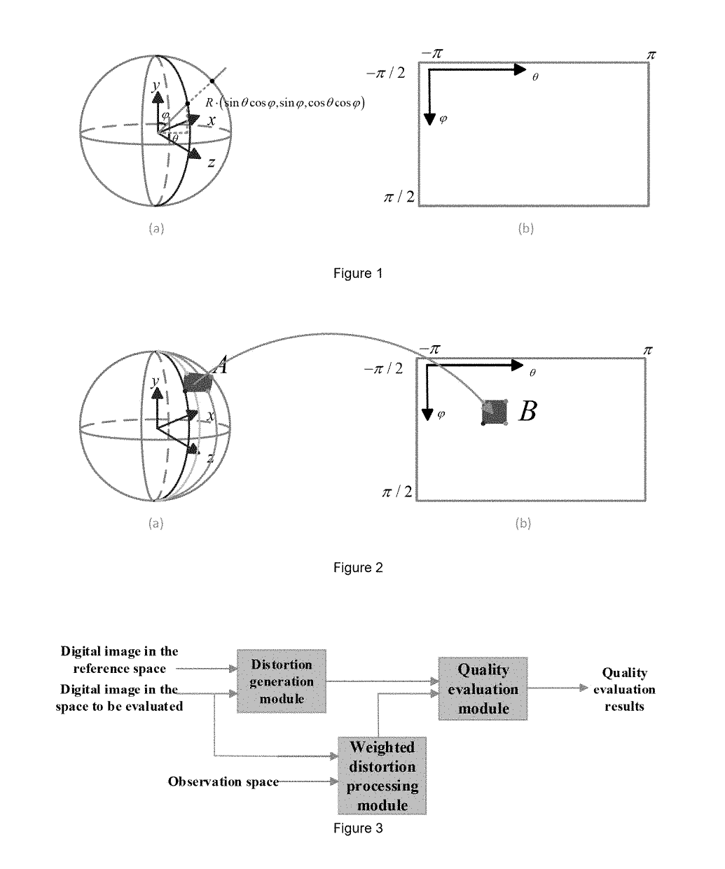

### DETAILED DESCRIPTION OF INVENTION

For the sake of simplicity of presentation, the processing units in the following embodiments may have different sizes and shapes, such as W×H rectangles, W×W squares, 1×1 single pixels, and other special shapes such as triangles, hexagons, etc. Each processing unit comprises only one image component (e.g., R or G or B, Y or U or V), and may comprise all components of one image. Last but not least, the processing unit here can not represent the entire image.

For the sake of simplicity of presentation, without loss of generality, observation space in the following embodiments are defined as a sphere. Followings are some typical mapping space.

For the sake of simplicity of presentation, the cube map projection (CMP) format in the following embodiments is defined as follows: a cube having exterior contact with the sphere is utilized to describe the spherical scene. Points on the cube are defined as the intersection of cube plane and lines starting from the center of the sphere and terminating on the point of the sphere. The point on the cube can specify the unique corresponding point on the sphere. This CMP format is represented by cube space.

For the sake of simplicity of presentation, the rectangular pyramid format in the following embodiments is defined as follows: a rectangular pyramid having exterior contact with the sphere is utilized to describe the spherical scene. Points on the rectangular pyramid are defined as the intersection of rectangular pyramid plane and lines starting from the center of the sphere and terminating on the point of the sphere. The point on the rectangular pyramid can specify the unique corresponding point on the sphere. This rectangular pyramid format is represented by rectangular pyramid space.

For the sake of simplicity of presentation, the N-face format in the following embodiments is defined as follows: a N-face having exterior contact with the sphere is utilized to describe the spherical scene. Points on the N-face are defined as the intersection of N-face plane and lines starting from the center of the sphere and terminating on the point of the sphere. The point on the N-face can specify the unique corresponding point on the sphere. This N-face format is represented by N-face space.

For the sake of simplicity of presentation, difference function Diff(A₁, A₂) in embodiments is defined as followings: firstly, the precondition is that the representation space W₁ where A₁ belonging to must be linear to the representation space W₂ where A₂ belonging to and each pixel in A₁ must have unique corresponding pixel in A₂. Difference function Diff(A₁, A₂) can be the sum of the absolute value of differences of each pixel belonging to A₁ and A₂, or may be the mean squared error of A₁ and A₂, or the peak signal-to-noise ratio of A₁ and A₂. The difference function is not limited to those mentioned above.

### Embodiment 1

The first embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as:

Aₒᵣᵢ(θ′ₒ, φ′ₒ, Δ, σ)={|θ−θ′ₒ|≤Δ, |φ−φ′ₒ|≤σ}

where Δ and σ are constant, Δ is defined as half of unit length of θ axis of new reference space W′ᵣₑₚ, σ is defined as half of unit length of φ axis of new reference space W′ᵣₑₚ. For four peak (θ′ₒ−Δ, φ′ₒ−σ) [symbol] (θ′ₒ−Δ, φ′ₒ+σ) [symbol] (θ′ₒ+Δ, φ′ₒ−σ) [symbol] (θ′ₒ+Δ, φ′ₒ+σ) of the rectangular restricted by Aₒᵣᵢ(φ′ₒ, φ′ₒ, Δ, σ) their corresponding location on the sphere whose radius is R can be calculated by:

R·(sin(θ′ₒ−Δ)cos(φ′ₒ−σ), sin(φ′ₒ−σ), cos(θ′ₒ−Δ)cos(φ′ₒ−σ))

[symbol]

R·(sin(θ′ₒ−Δ)cos(φ′ₒ+σ), sin(φ′ₒ+σ), cos(θ′ₒ−Δ)cos(φ′ₒ+σ))

[symbol]

R·(sin(θ′ₒ+Δ)cos(φ′ₒ−σ), sin(φ′ₒ−σ), cos(θ′ₒ+Δ)cos(φ′ₒ−σ))

[symbol]

R·(sin(θ′ₒ+Δ)cos(φ′ₒ+σ), sin(φ′ₒ+σ), cos(θ′ₒ+Δ)cos(φ′ₒ+σ));

Area surrounded by those four points S(Aₒᵣᵢ(θ′ₒ, φ′ₒ, Δ, σ)) is:

S(Aₒᵣᵢ(θ′ₒ, φ′ₒ, Δ, σ))≈ϑ(Δ, σ)·R²·cos(φ′ₒ)

where, ϑ(Δ, σ) is function of Δ [symbol] σ, when Δ and σ are constant, ϑ(Δ, σ) is also a constant as 2\sqrt{2}·\sqrt{1−cos(2Δ)}·cos(σ)·sin(Δ);

(3) In the reference space, the ratio of current processing unit Aₒᵣᵢ(θ′ₒ, φ′ₒ, Δ, σ) corresponding to (θₒ, φₒ) in the observation space Wᵣₑₚ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ε(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wᵣₑₚ, which is not constant;

(4) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·Eₒᵣᵢ(Aₒᵣᵢ(θ′ₒ, φ′ₒ, Δ, σ))·|pₜ(θ′ₜ, φ′ₜ)−pₒ(θ′ₒ, ϕ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 2

The second embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit A_{proc}(θ′ₜ, φ′ₜ, Δ, σ) is presented as:

A_{proc}(θ′ₜ, φ′ₜ, Δ, σ)={|θ−θ′ₜ|≤Δ, |φ−φ′ₜ|≤σ}

Where, Δ and σ are constant, Δ is defined as half of unit length of θ axis of new reference space W′ₜ, σ is defined as half of unit length of φ axis of new reference space W′ₜ. For four peak (θ′ₜ−Δ, φ′ₜ−σ) [symbol] (θ′ₜ−Δ, φ′ₜ+σ) [symbol] (θ′ₜ+Δ, φ′ₜ−σ) [symbol] (θ′ₜ+Δ, φ′ₜ+σ) of the rectangular restricted by A_{proc}(θ′ₜ, φ′ₜ, Δ, σ) their corresponding location on the sphere whose radius is R can be calculated by:

R·(sin(θ′ₜ−Δ)cos(φ′ₜ−σ), sin(φ′ₜ−σ), cos(θ′ₜ−Δ)cos(φ′ₜ−σ))

[symbol]

R·(sin(θ′ₜ−Δ)cos(φ′ₜ+σ), sin(φ′ₜ+σ), cos(θ′ₜ−Δ)cos(φ′ₜ+σ))

[symbol]

R·(sin(θ′ₜ+Δ)cos(φ′ₜ−σ), sin(φ′ₜ−σ), cos(θ′ₜ+Δ)cos(φ′ₜ−σ))

[symbol]

R·(sin(θ′ₜ+Δ)cos(φ′ₜ+σ), sin(φ′ₜ+σ), cos(θ′ₜ+Δ)cos(φ′ₜ+σ));

Area surrounded by those four points S(A_{proc}(θ′ₜ, φ′ₜ, Δ, σ)) is:

S(A_{proc}(θ′ₜ, φ′ₜ, Δ, σ))≈ϑ(Δ, σ)·R²·cos(φ′ₜ)

where, ε(Δ, σ) is function of Δ [symbol] σ, when Δ and σ are constant, ϑ(Δ, σ) is also a constant as 2\sqrt{2}·\sqrt{1−cos(2Δ)}·cos(σ)·sin(Δ);

(3) In the space to be evaluated, the ratio of current processing unit A_{proc}(θ′ₜ, φ′ₜ, Δ, σ) corresponding to (θₜ, φₜ) in the observation space Wᵣₑₚ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wᵣₑₚ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant(can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 3

The third embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as:

Aₒᵣᵢ(θ′ₒ, φ′ₒ, Δ, σ)={|θ−θ′ₒ|≤Δ, |φ−φ′ₒ|≤σ}

Where, Δ and σ are constant, Δ is defined as half of unit length of θ axis of new reference space W′ᵣₑₚ, σ is defined as half of unit length of φ axis of new reference space W′ᵣₑₚ. For four peak (θ′ₒ−Δ, φ′ₒ−σ) [symbol] (θ′ₒ−Δ, φ′ₒ+σ) [symbol] (θ′ₒ+Δ, φ′ₒ−σ) [symbol] (θ′ₒ+Δ, φ′ₒ+σ) of the rectangular restricted by Aₒᵣᵢ(θ′ₒ, φ′ₒ, Δ, σ) their corresponding location on the sphere whose radius is R can be calculated by:

R·(sin(θ′ₒ−Δ)cos(φ′ₒ−σ), sin(φ′ₒ−σ), cos(θ′ₒ−Δ)cos(φ′ₒ−σ))

[symbol]

R·(sin(θ′ₒ−Δ)cos(φ′ₒ+σ), sin(φ′ₒ+σ), cos(θ′ₒ−Δ)cos(φ′ₒ+σ))

[symbol]

R·(sin(θ′ₒ+Δ)cos(φ′ₒ−σ), sin(φ′ₒ−σ), cos(θ′ₒ+Δ)cos(φ′ₒ−σ))

[symbol]

R·(sin(θ′ₒ+Δ)cos(φ′ₒ+σ), sin(φ′ₒ+σ), cos(θ′ₒ+Δ)cos(φ′ₒ+σ));

Area surrounded by those four points S(Aₒᵣᵢ(θ′ₒ, φ′ₒ, Δ, σ)) is:

S(Aₒᵣᵢ(θ′ₒ, φ′ₒ, Δ, σ))≈ϑ(Δ, σ)·R²·cos(φ′ₒ)

where, ϑ(Δ, σ) is function of Δ [symbol] σ, when Δ and σ are constant, ϑ(Δ, σ) is also a constant as 2\sqrt{2}·\sqrt{1−cos(2Δ)}·cos(σ)·sin(Δ);

(3) In the reference space, the ratio of current processing unit Aₒᵣᵢ(θ′ₒ, φ′ₒ, Δ, σ) corresponding to (θₒ, φₒ) in the observation space Wₒ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ϑ(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wₒ, which is not constant;

(4) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·E ₒᵣᵢ(Aₒᵣᵢ(θ′ₒ, φ′ₒ, Δ, σ)·|pₜ(θ′ₜ, φ′ₜ)−pₒ(θ′ₒ, φ′ₒ)|, where c is constant (can be set as 1)₆₀₂ pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 4

The fourth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit A_{proc}(θ′ₜ, φ′ₜ, Δ, σ) is presented as:

A_{proc}(θ′ₜ, φ′ₜ, Δ, σ)={|θ−θ′ₜ|≤Δ, |φ−φ′ₜ|≤σ}

Where, Δ and σ are constant, Δ is defined as half of unit length of θ axis of new reference space W′ₜ, σ is defined as half of unit length of φ axis of new reference space W′ₜ. For four peak (θ′ₜ−Δ, φ′ₜ−σ) [symbol] (θ′ₜ−Δ, φ′ₜ+σ) [symbol] (θ′ₜ+Δ, φ′ₜ−σ) [symbol] (θ′ₜ+Δ, φ′ₜ+σ) of the rectangular restricted by A_{proc}(θ′ₜ, φ′ₜ, Δ, σ) their corresponding location on the sphere whose radius is R can be calculated by:

R·(sin(θ′ₜ−Δ)cos(φ′ₜ−σ), sin(φ′ₜ−σ), cos(θ′ₜ−Δ)cos(φ′ₜ−σ))

[symbol]

R·(sin(θ′ₜ−Δ)cos(φ′ₜ+σ), sin(φ′ₜ+σ), cos(θ′ₜ−Δ)cos(φ′ₜ+σ))

[symbol]

R·(sin(θ′ₜ+Δ)cos(φ′ₜ−σ), sin(φ′ₜ−σ), cos(θ′ₜ+Δ)cos(φ′ₜ−σ))

[symbol]

R·(sin(θ′ₜ+Δ)cos(φ′ₜ+σ), sin(φ′ₜ+σ), cos(θ′ₜ+Δ)cos(φ′ₜ+σ));

Area surrounded by those four points S(A_{proc}(θ′ₜ, φ′ₜ, Δ, σ)) is:

S(A_{proc}(θ′ₜ, φ′ₜ, Δ, σ))≈ϑ(Δ, σ)·R²·cos(φ′ₜ)

where, ϑ(Δ, σ) is function of Δ [symbol] σ, when Δ and σ are constant, ϑ(Δ, σ) is also a constant as 2\sqrt{2}·\sqrt{1−cos(2Δ)}·cos(σ)·sin(Δ);

(3) In the space to be evaluated, the ratio of current processing unit A_{proc}(θ′ₜ, φ′ₜ, Δ, σ) corresponding to (θₜ, φₜ) in the observation space Wₒ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wₒ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 5

The fifth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as the region of three nearest pixels of pixel (θₒ, φₒ); Mapping this region onto the spherical observation space whose radius is R, the area covered on sphere is S(Aₒᵣᵢ(θ′ₒ, φ′ₒ, Δ, σ)).

In the reference space, the ratio of current processing unit Aₒᵣᵢ(θ′ₒ, φ′ₒ, Δ, σ) corresponding to (θₒ, φₒ) in the observation space Wₒ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ϑ(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wₒ, which is not constant;

(3) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·Eₒᵣᵢ(Aₒᵣᵢ(θ′ₒ, φ′ₒ, Δ, σ))·|pₜ(θ′ₜ, φ′ₜ)−pₒ(θ′ₒ, φ′ₒ)|, where c is constant (can be set as 1)₆₀₂ pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(4) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 6

The sixth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as the region of four nearest pixels of pixel (θₒ, φₒ); Mapping this region onto the spherical observation space whose radius is R, the area covered on sphere is S(Aₒᵣᵢ(θ′ₒ, φ′ₒ, Δ, σ)).

In the reference space, the ratio of current processing unit Aₒᵣᵢ(θ′ₒ, φ′ₒ, Δ, σ) corresponding to (θₒ, φₒ) in the observation space Wₒ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ϑ(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wₒ, which is not constant;

(3) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·Eₒᵣᵢ(Aₒᵣᵢ(θ′ₒ, φ′ₒ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(4) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 7

The seventh embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as the surrounded region of three nearest pixels of pixel (θₒ, φₒ) and their center points; Mapping this region onto the spherical observation space whose radius is R, the area covered on sphere is S(Aₒᵣᵢ(θ′ₒ, φ′ₒ, Δ, σ)).

In the reference space, the ratio of current processing unit Aₒᵣᵢ(θ′ₒ, φ′ₒ, Δ, σ) corresponding to (θₒ, φₒ) in the observation space Wₒ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ϑ(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wₒ, which is not constant;

(3) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·Eₒᵣᵢ(Aₒᵣᵢ(θ′ₒ, φ′ₒ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(4) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 8

The eighth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to resent images and space to be evaluated Wₜ is converted to new space to be evaluated W′ₜ;

(2) One pixel (θₒ, φₒ) in reference space Wᵣₑₚ is corresponding to (θ′ₒ, φ′ₒ) in the new reference space W′ᵣₑₚ, the corresponding processing unit Aₒᵣᵢ(θ′ₒ, φ′ₒ, Δ, σ) is presented as the surrounded region of four nearest pixels of pixel (θₒ, φₒ) and their center points; Mapping this region onto the spherical observation space whose radius is R, the area covered on sphere is S(Aₒᵣᵢ(θ′ₒ, φ′ₒ, Δ, σ)).

In the reference space, the ratio of current processing unit Aₒᵣᵢ(θ′ₒ, φ′ₒ, Δ, σ) corresponding to (θₒ, φₒ) in the observation space Wₒ:

Eₒᵣᵢ(Aₒᵣᵢ(θ′ₒ, φ′ₒ, Δ, σ))=S(Aₒᵣᵢ(θ′ₒ, φ′ₒ, Δ, σ))/(4πR²)≈ϑ(Δ, σ)·cos(φ′ₒ)/(4π), where Eₒᵣᵢ(Aₒᵣᵢ(θ′ₒ, φ′ₒ, Δ, σ)) is relate to the location of S(Aₒᵣᵢ(θ′ₒ, φ′ₒ, Δ, σ)) in the observation space Wₒ, which is not constant;

(3) The quality Q of (θ′ₜ, φ′ₜ) in the new space to be evaluated W′ₜ, which is corresponding to (θ′ₒ, φ′ₒ) in the new reference space W′ᵣₑₚ:

[symbol] (θ′ₜ, φ′ₜ)=c·Eₒᵣᵢ(Aₒᵣᵢ(θ′ₒ, φ′ₒ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(4) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 9

The ninth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit A_{proc}(θ′ₜ, φ′ₜ, Δ, σ) is presented as the region of three nearest pixels of pixel (θₜ, φₜ); Mapping this region onto the spherical observation space whose radius is R, the area covered on sphere is S(A_{proc}(θ′ₜ, φ′ₜ)).

(3) In the space to be evaluated, the ratio of current processing unit A_{proc}(θ′ₜ, φ′ₜ, Δ, σ) corresponding to (θₜ, φₜ) in the observation space Wₒ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wₒ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 10

The tenth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit A_{proc}(θ′ₜ, φ′ₜ, Δ, σ) is presented as the region of four nearest pixels of pixel (θₜ, φₜ); Mapping this region onto the spherical observation space whose radius is R, the area covered on sphere is S(A_{proc}(θ′ₜ, φ′ₜ)).

(3) In the space to be evaluated, the ratio of current processing unit A_{proc}(θ′ₜ, φ′ₜ, Δ, σ) corresponding to (θₜ, φₜ) in the observation space Wₒ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wₒ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 11

The eleventh embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit A_{proc}(θ′ₜ, φ′ₜ, Δ, σ) is presented as the region of three nearest pixels of pixel (θₒ, φₒ) and their center points; Mapping this region onto the spherical observation space whose radius is R, the area covered on sphere is S(A_{proc}(θ′ₜ, φ′ₜ)).

(3) In the space to be evaluated, the ratio of current processing unit A_{proc}(θ′ₜ, φ′ₜ, Δ, σ) corresponding to (θₜ, φₜ) in the observation space Wₒ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wₒ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 12

The twelfth embodiment of the patent relates to a digital image quality evaluation method. Several basic definitions need to be made. The observation space Wₒ to present observing digital images is a sphere. The representation space of digital images to be evaluated Wₜ is equirectangular projection (ERP) format. The representation space of reference digital images Wᵣₑₚ is ERP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (θₜ, φₜ) in the space to be evaluated Wₜ is corresponding to (θ′ₜ, φ′ₜ) in the new reference space W′ₜ, the corresponding processing unit ^{A}_{proc}(θ′ₜ, φ′ₜ, Δ, σ) is presented as the region of four nearest pixels of pixel (θₒ, φₒ) and their center points; Mapping this region onto the spherical observation space whose radius is R, the area covered on sphere is S(A_{proc}(θₜ, φₜ)).

(3) In the space to be evaluated, the ratio of current processing unit A_{proc}(θ′ₜ, φ′ₜ, Δ, σ) corresponding to (θₜ, φₜ) in the observation space Wₒ:

E_{proc}(A_{proc}(θ′ₜ, φ′ₜ, Δ, σ))=S(A_{proc}(θ′ₜ, φ′ₜ, Δ, σ))/(4πR²)≈ϑ(Δ, σ)·cos(φ′ₜ)/(4π), where E_{proc}(A_{proc}(θ′ₜ, φ′ₜ, Δ, σ)) is relate to the location of S(A_{proc}(θ′ₜ, φ′ₜ, Δ, σ)) in the observation space Wₒ, which is not constant;

(4) The quality Q of (θ′ₒ, φ′ₒ) in the new reference space W′ₒ, which is corresponding to (θ′ₜ, φ′ₜ) in the new space to be evaluated W′ₜ:

[symbol] (θ′ₜ, φ′ₜ)=c·E_{proc}(A_{proc}(θ′ₜ, φ′ₜ, Δ, σ))·|pₜ(θ′ₜ, φ′ₜ)−pₒ(θ′ₒ, φ′ₒ)|, where c is constant (can be set as 1)_{∘} pₜ(θ′ₜ, φ′ₜ) represents the value of pixel at (θ′ₜ, φ′ₜ) in the new space to be evaluated, pₒ(θ′ₒ, φ′ₒ) represents the value of pixel at (θ′ₒ, φ′ₒ) in the new reference space;

(5) The quality of the entire image is presented as

$$Quality = {\sum }_{( {θ}_{t}^{′} , {ϕ}_{t}^{′} ) ∈ {W}_{t}^{′}} Q ( {θ}_{t}^{′} , {ϕ}_{t}^{′} )$$

### Embodiment 13

The thirteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₒ, yₒ, zₒ) in reference space Wᵣₑₚ is corresponding to (x′ₒ, y′ₒ, z′ₒ) in the new reference space W′ᵣₑₚ, without loss of generality, the z value in (x′ₒ, y′ₒ, z′ₒ) is a constant. Assuming the corresponding processing unit Aₒᵣᵢ(x′ₒ, y′ₒ, z′ₒ, Δ, σ) is presented as:

Aₒᵣᵢ(x′ₒ, y′ₒ, z′ₒ, Δ, σ)={|x−x′ₒ|≤Δ, |y−y′ₒ|≤σ}

Where, Δ and σ are constant, Δ is defined as half of unit length of x axis of new reference space W′ᵣₑₚ, σ is defined as half of unit length of y axis of new reference space W′ᵣₑₚ. For four peak (x′ₒ−Δ, y′ₒ−σ, z′ₒ) [symbol] (x′ₒ−Δ, y′ₒ+σ, z′ₒ) [symbol] (x′ₒ+Δ, y′ₒ−σ, z′ₒ) [symbol] (x′ₒ+Δ, y′ₒ+σ, z′ₒ) of the rectangular restricted by Aₒᵣᵢ(x′ₒ, y′ₒ, z′ₒ, Δ, σ), mapping those four mapped points onto sphere and corresponding mapped spherical area surrounded by four mapped points is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ, Δ, σ) corresponding to (xₒ, yₒ, zₒ) in the observation space Wₒ:

$${E}_{ori} ( {A}_{ori} ( {x}_{o}^{′} , {y}_{o}^{′} , {z}_{o}^{′} , Δ , σ ) ) = {( 3 + \frac{{x}_{o}^{{′}^{2}} + {y}_{o}^{{′}^{2}} - ( {x}_{o}^{′} + {y}_{o}^{′} ) * a}{{a}^{2} \text{/} 4} )}^{- 3 \text{/} 2}$$

E_{proc}(A_{proc}(x′ₜ, y′ₜ, z′ₜ, Δ, σ)) is relate to the location of S(A_{proc}(x′ₜ, y′ₜ, z′ₜ, Δ, σ)) in the observation space Wₒ, which is not constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 14

The fourteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated w′ₜ;

(2) One pixel (xₜ, yₜ, zₜ) in the space to be evaluated Wₜ is corresponding to (x′ₜ, y′ₜ, z′ₜ) in the new space to be evaluated W′ᵣₑₚ, without loss of generality, the z value in (x′ₜ, y′ₜ, z′ₜ) is a constant. Assuming the corresponding processing unit A_{proc}(x′ₜ, y′ₜ, z′ₜ, Δ, σ) is presented as:

A_{proc}(x′ₜ, y′ₜ, z′ₜ, Δ, σ)={|x−x′ₜ|≤Δ, |y−y′ₜ|≤σ}

Where, Δ and σ are constant, Δ is defined as half of unit length of x axis of new space to be evaluated W′ₜ, σ is defined as half of unit length of y axis of new space to be evaluated W′ₜ. For four peak (x′ₒ−Δ, y′ₒ−σ, z′ₒ) [symbol] (x′ₒ−Δ, y′ₒ+σ, z′ₒ) [symbol] (x′ₒ+Δ, y′ₒ−σ, z′ₒ) [symbol] (x′ₒ+Δ, y′ₒ+σ, z′ₒ) of the rectangular restricted by A_{proc}(x′ₜ, y′ₜ, z′ₜ, Δ, σ), mapping those four mapped points onto sphere and corresponding mapped spherical area surrounded by four mapped points is S(A_{proc}(x′ₜ, y′ₜ, z′ₜ, Δ, σ)).

(3) In the space to be evaluated, the ratio of current processing unit A_{proc}(x′ₜ, y′ₜ, z′ₜ, Δ, σ) corresponding to (xₜ, yₜ, zₜ) in the observation space Wₒ:

$${E}_{proc} ( {A}_{proc} ( {x}_{t}^{′} , {y}_{t}^{′} , {z}_{t}^{′} , Δ , σ ) ) = {( 3 + \frac{{x}_{t}^{{′}^{2}} + {y}_{t}^{{′}^{2}} - ( {x}_{t}^{′} + {y}_{t}^{′} ) * a}{{a}^{2} \text{/} 4} )}^{- 3 \text{/} 2}$$

E_{proc}(A_{proc}(x′ₜ, y′ₜ, z′ₜ, Δ, σ)) is relate to the location of S(A_{proc}(x′ₜ, y′ₜ, z′ₜ, Δ, σ)) in the observation space Wₒ, which is not constant;

(4) The quality Q of (x′ₜ, y′ₜ, z′ₜ) in the new space to be evaluated W′ₜ, which is corresponding to xₒ,yₒ,zₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 15

The fifteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₒ, yₒ, zₒ) in reference space Wᵣₑₚ is corresponding to (x′ₒ, y′ₒ, z′ₒ) the new reference space W′ᵣₑₚ, without loss of generality, the z value in (x′ₒ, y′ₒ, z′ₒ) is a constant. Assuming the corresponding processing unit Aₒᵣᵢ(x′ₒ, y′ₒ, z′ₒ, Δ, σ) is presented as:

Aₒᵣᵢ(x′ₒ, y′ₒ, z′ₒ, Δ, σ)={|x−x′ₒ|≤Δ, |y−y′ₒ|≤σ}

Where, Δ and σ are constant, Δ is defined as unit length of x axis of new reference space W′ᵣₑₚ, σ is defined as unit length of y axis of new reference space W′ᵣₑₚ. For four peak (x′ₒ−Δ, y′ₒ−σ, z′ₒ) [symbol] (x′ₒ−Δ, y′ₒ+σ, z′ₒ) [symbol] (x′ₒ+Δ, y′ₒ−σ, z′ₒ) [symbol] (x′ₒ+Δ, y′ₒ+σ, z′ₒ) of the rectangular restricted by Aₒᵣᵢ(x′ₒ, y′ₒ, z′ₒ, Δ, σ), mapping those four mapped points onto sphere and corresponding mapped spherical area surrounded by four mapped points is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ, Δ, σ) corresponding to (xₒ, yₒ, zₒ) in the observation space Wₒ:

$${E}_{ori} ( {A}_{ori} ( {x}_{o}^{′} , {y}_{o}^{′} , {z}_{o}^{′} , Δ , σ ) ) = {( 3 + \frac{{x}_{o}^{{′}^{2}} + {y}_{o}^{{′}^{2}} - ( {x}_{o}^{′} + {y}_{o}^{′} ) * a}{{a}^{2} \text{/} 4} )}^{- 3 \text{/} 2}$$

Eₒᵣᵢ(Aₒᵣᵢ(x′ₒ, y′ₒ, z′ₒ, Δ, σ)) is relate to the location of S(Aₒᵣᵢ(x′ₒ, y′ₒ, z′ₒ, Δ, σ)) in the observation space Wₒ, which is not constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 16

The sixteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₜ, yₜ, zₜ) in the space to be evaluated Wₜ is corresponding to (x′ₜ, y′ₜ, z′ₜ) in the new space to be evaluated W′ₜ, without loss of generality, the z value in (x′ₜ, y′ₜ, z′ₜ) is a constant. Assuming the corresponding processing unit A_{proc}(x′ₜ, y′ₜ, z′ₜ, Δ, σ) is presented as:

A_{proc}(x′ₜ, y′ₜ, z′ₜ, Δ, σ)={|x−x′ₜ|≤Δ, |y−y′ₜ|≤σ}

Where, Δ and σ are constant, Δ is defined as unit length of x axis of new space to be evaluated W′ₜ, σ is defined as unit length of y axis of new space to be evaluated W′ₜ. For four peak (x′ₒ−Δ, y′ₒ−σ, z′ₒ) [symbol] (x′ₒ−Δ, y′ₒ+σ, z′ₒ) [symbol] (x′ₒ+Δ, y′ₒ−σ, z′ₒ) [symbol] (x′ₒ+Δ, y′ₒ+σ, z′ₒ) of the rectangular restricted by A_{proc}(x′ₜ, y′ₜ, z′ₜ, Δ, σ), mapping those four mapped points onto sphere and corresponding mapped spherical area surrounded by four mapped points is S(A_{proc}(x′ₜ, y′ₜ, z′ₜ, Δ, σ)).

(3) In the space to be evaluated, the ratio of current processing unit A_{proc}(x′ₜ, y′ₜ, z′ₜ, Δ, σ) corresponding to (xₜ , yₜ, zₜ) in the observation space Wₒ:

$${E}_{proc} ( {A}_{proc} ( {x}_{t}^{′} , {y}_{t}^{′} , {z}_{t}^{′} , Δ , σ ) ) = {( 3 + \frac{{x}_{t}^{{′}^{2}} + {y}_{t}^{{′}^{2}} - ( {x}_{t}^{′} + {y}_{t}^{′} ) * a}{{a}^{2} \text{/} 4} )}^{- 3 \text{/} 2}$$

E_{proc}(A_{proc}(x′ₜ, y′ₜ, z′ₜ, Δ, σ)) is relate to the location of S(A_{proc}(x′ₜ, y′ₜ, z′ₜ, Δ, σ)) in the observation space Wₒ, which is not constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 17

The seventeenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₒ, yₒ, zₒ) in reference space Wᵣₑₚ is corresponding to (x′ₒ, y′ₒ, z′ₒ) the new reference space W′ᵣₑₚ, without loss of generality, the z value in (x′ₒ, y′ₒ, z′ₒ) is a constant. Assuming the corresponding processing unit Aₒᵣᵢ(x′ₒ, y′ₒ, z′ₒ, Δ, σ) is presented as the region of three nearest pixels of pixel (xₒ, yₒ, zₒ); Mapping this region onto the spherical observation space whose radius is R, the area covered on sphere is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ) corresponding to (xₒ, yₒ, zₒ) in the observation space Wₒ:

Eₒᵣᵢ(Aₒᵣᵢ(x′ₒ, y′ₒ, z′ₒ)) is relate to the location of S(Aₒᵣᵢ(x′ₒ, y′ₒ, z′ₒ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 18

The eighteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₒ, yₒ, zₒ) in reference space Wᵣₑₚ is corresponding to (x′ₒ, y′ₒ, z′ₒ) in the new reference space W′ᵣₑₚ, without loss of generality, the z value in (x′ₒ, y′ₒ, z′ₒ) is a constant. Assuming the corresponding processing unit Aₒᵣᵢ(x′ₒ, y′ₒ, z′ₒ, Δ, σ) is presented as the region of four nearest pixels of pixel (xₒ, yₒ, zₒ); Mapping this region onto the spherical observation space whose radius is R, the area covered on sphere is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ) corresponding to (xₒ, yₒ, zₒ) in the observation space Wₒ:

Eₒᵣᵢ(Aₒᵣᵢ(x′ₒ, y′ₒ, z′ₒ)) is relate to the location of S(Aₒᵣᵢ(x′ₒ, y′ₒ, z′ₒ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 19

The nineteenth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₒ, yₒ, zₒ) in reference space Wᵣₑₚ is corresponding to (x′ₒ, y′ₒ, z′ₒ) in the new reference space W′ᵣₑₚ, without loss of generality, the z value in (x′ₒ, y′ₒ, z′ₒ)is a constant. Assuming the corresponding processing unit Aₒᵣᵢ(x′ₒ, y′ₒ, z′ₒ, Δ, σ) is presented as the region of three nearest pixels of pixel (xₒ, yₒ, zₒ) and their center points; Mapping this region onto the spherical observation space whose radius is R, the area covered on sphere is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ) corresponding to (xₒ, yₒ, zₒ) in the observation space Wₒ:

Eₒᵣᵢ(Aₒᵣᵢ(x′ₒ, y′ₒ, z′ₒ)) is relate to the location of S(Aₒᵣᵢ(x′ₒ, y′ₒ, z′ₒ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 20

The twentieth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated w′ₜ;

(2) One pixel (xₒ, yₒ, zₒ) in reference space Wᵣₑₚ is corresponding to (x′ₒ, y′ₒ, z′ₒ) in the new reference space W′ᵣₑₚ, without loss of generality, the z value in (x′ₒ, y′ₒ, z′ₒ)is a constant. Assuming the corresponding processing unit Aₒᵣᵢ(x′ₒ, y′ₒ, z′ₒ, Δ, σ) is presented as the region of four nearest pixels of pixel (xₒ, yₒ, zₒ) and their center points; Mapping this region onto the spherical observation space whose radius is R, the area covered on sphere is S(Aₒᵣᵢ(x′ₒ, y′ₒ, z′ₒ, Δ, σ)).

(3) In the reference space, the ratio of current processing unit Aₒᵣᵢ(x′ₒ, y′ₒ, z′ₒ) corresponding to (xₒ, yₒ,zₒ) in the observation space Wₒ:

Eₒᵣᵢ(Aₒᵣᵢ(x′ₒ, y′ₒ, z′ₒ)) is relate to the location of s(Aₒᵣᵢ(x′ₒ, y′ₒ, z′ₒ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 21

The twenty-first embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₜ, yₜ, zₜ) in the space to be evaluated Wₜ is corresponding to (x′ₜ, y′ₜ, z′ₜ) in the new reference space W′ₜ, without loss of generality, the z value in (x′ₜ, y′ₜ, z′ₜ) is a constant. Assuming the corresponding processing unit A_{proc}(x′ₜ, y′ₜ, z′ₜ) is presented as the region of three nearest pixels of pixel (xₜ, yₜ, zₜ); Mapping this region onto the spherical observation space whose radius is R, the area covered on sphere is S(A_{proc}(x′ₜ, y′ₜ, z′ₜ)).

(3) In the space to be evaluated, the ratio of current processing unit A_{proc}(x′ₜ, y′ₜ, z′ₜ) corresponding to (xₜ, yₜ, zₜ) in the observation space Wₒ: E_{proc}(A_{proc}(x′ₜ, y′ₜ, z′ₜ)).

E_{proc}(A_{proc}(x′ₜ, y′ₜ, z′ₜ) is relate to the location of S(A_{proc}(x′ₜ, y′ₜ, z′ₜ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 22

The twenty-second embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₜ, yₜ, zₜ) in the space to be evaluated Wₜ is corresponding to (x′ₜ, y′ₜ, z′ₜ) in the new reference space W′ₜ, without loss of generality, the z value in (x′ₜ, y′ₜ, z′ₜ) is a constant. Assuming the corresponding processing unit A_{proc}(x′ₜ, y′ₜ, z′ₜ) is presented as the region of four nearest pixels of pixel (xₜ, yₜ, zₜ); Mapping this region onto the spherical observation space whose radius is R, the area covered on sphere is S(A_{proc}(x′ₜ, y′ₜ, z′ₜ)).

(3) In the space to be evaluated, the ratio of current processing unit A_{proc}(x′ₜ, y′ₜ, z′ₜ) corresponding to (xₜ, yₜ, zₜ) in the observation space Wₒ: E_{proc}(A_{proc}(x′ₜ, y′ₜ, z′ₜ)).

E_{proc}(A_{proc}(x′ₜ, y′ₜ, z′ₜ) is relate to the location of S(A_{proc}(x′ₜ, y′ₜ, z′ₜ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 23

The twenty-third embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₜ, yₜ, zₜ) in the space to be evaluated Wₜ is corresponding to (x′ₜ, y′ₜ, z′ₜ) in the new reference space W′ₜ, without loss of generality, the z value in (x′ₜ, y′ₜ, z′ₜ) is a constant. Assuming the corresponding processing unit A_{proc}(x′ₜ, y′ₜ, z′ₜ) is presented as the region of three nearest pixels of pixel (xₜ, yₜ, zₜ) and their center points; Mapping this region onto the spherical observation space whose radius is R, the area covered on sphere is S(A_{proc}(x′ₜ, y′ₜ, z′ₜ)).

(3) In the space to be evaluated, the ratio of current processing unit A_{proc}(x′ₜ, y′ₜ, z′ₜ) corresponding to (xₜ , yₜ,zₜ) in the observation space Wₒ: E_{proc}(A_{proc}(x′ₜ, y′ₜ, z′ₜ)).

E_{proc}(A_{proc}(x′ₜ, y′ₜ, z′ₜ) is relate to the location of S(A_{proc}(x′ₜ, y′ₜ, z′ₜ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 24

The twenty-fourth embodiment of the patent relates to a digital image quality evaluation method. Several basic definitions need to be made. The observation space Wₒ to present observing digital images is a sphere. The representation space of digital images to be evaluated Wₜ is cube map projection (CMP) format. The representation space of reference digital images Wᵣₑₚ is CMP format. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel (xₜ, yₜ, zₜ) in the space to be evaluated Wₜ is corresponding to (x′ₜ, y′ₜ, z′ₜ) in the new reference space W′ₜ, without loss of generality, the z value in (x′ₜ, y′ₜ, z′ₜ) is a constant. Assuming the corresponding processing unit A_{proc}(x′ₜ, y′ₜ, z′ₜ) is presented as the region of four nearest pixels of pixel (xₜ, yₜ, zₜ) and their center points; Mapping this region onto the spherical observation space whose radius is R, the area covered on sphere is S(A_{proc}(x′ₜ, y′ₜ, z′ₜ)).

(3) In the space to be evaluated, the ratio of current processing unit A_{proc}(x′ₜ, y′ₜ, z′ₜ) corresponding to (xₜ, yₜ, zₜ) in the observation space Wₒ: E_{proc}(A_{proc}(x′ₜ, y′ₜ, z′ₜ)).

E_{proc}(A_{proc}(x′ₜ, y′ₜ, z′ₜ)) is relate to the location of S(A_{proc}(x′ₜ, y′ₜ, z′ₜ)) in the observation space Wₒ, which is not a constant;

(4) The quality Q of (x′ₜ, y′ₜ, z′ₜ) in the new space to be evaluated W′ₜ, which is corresponding to (x′ₒ, y′ₒ, z′ₒ) in the new reference space W′ᵣₑₚ:

[symbol] (x′ₜ, y′ₜ, z′ₜ)=c·E_{proc}(A_{proc}(x′ₜ, y′ₜ, z′ₜ, Δ, σ))·|pₜ(x′ₜ, y′ₜ, z′ₜ)−pₒ(x′ₒ, y′ₒ, z′_{⊚})|, where c is constant (can be set as 1)_{∘} pₜ(x′ₜ, y′ₜ, z′ₜ) represents the value of pixel at (x′ₜ, y′ₜ, z′ₜ) in the new space to be evaluated, pₜ(x′ₒ, y′ₒ, z′ₒ) represents the value of pixel at (x′ₒ, y′ₒ, z′ₒ) in the new reference space;

(5) The quality of the entire image is presented as

$$Quality = {\sum }_{( {x}_{t}^{′} , {y}_{t}^{′} , {z}_{t}^{′} ) ∈ {W}_{t}^{′}} Q ( {x}_{t}^{′} , {y}_{t}^{′} , {z}_{t}^{′} )$$

### Embodiment 25

The twenty-fifth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space W′ᵣₑₚ. Assuming the corresponding processing unit Aₒᵣᵢ(x′ₒ) is presented as the region of three nearest pixels of pixel xₒ; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 26

The twenty-sixth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space W′ᵣₑₚ. Assuming the corresponding processing unit Aₒᵣᵢ(x′ₒ) is presented as the region of four nearest pixels of pixel xₒ; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of x′ₜ in the new space to be evaluated W′ₜ, which is corresponding to x′ₒin the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 27

The twenty-seventh embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space W′ᵣₑₚ. Assuming the corresponding processing unit Aₒᵣᵢ(x′ₒ) is presented as the region of three nearest pixels of pixel xₒ and their center points; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of X′ₜ in the new space to be evaluated W′ₜ, which is corresponding to x′ₒin the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 28

The twenty-eighth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space W′ᵣₑₚ. Assuming the corresponding processing unit Aₒᵣᵢ(x′ₒ) is presented as the region of four nearest pixels of pixel xₒ and their center points; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 29

The twenty-ninth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wₒ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space W′ₒ. Assuming the corresponding processing unit Aₒᵣᵢ(x′ₒ) is presented as the region within unit length to pixel xₒ; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of X′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 30

The thirtieth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₒ in reference space Wᵣₑₚ is corresponding to x′ₒ in the new reference space Wᵣₑₚ. Assuming the corresponding processing unit Aₒᵣᵢ(x′ₒ) is presented as the region within unit length to pixel xₒ; Mapping this region onto the spherical observation space whose radius is R, the area covered on sphere is S(Aₒᵣᵢ(x′ₒ)).

(3) In the reference space, the ratio of current processing unit Aₒᵣᵢ(x′ₒ) corresponding to xₒ in the observation space Wₒ: Eₒᵣᵢ(Aₒᵣᵢ(x′ₒ)).

Eₒᵣᵢ(Aₒᵣᵢ(x′ₒ)) is relate to the location of S(Aₒᵣᵢ(x′ₒ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 31

The thirty-first embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₜ in the space to be evaluated Wₜ is corresponding to x′ₜ in the new space to be evaluated W′ₜ. Assuming the corresponding processing unit A_{proc}(x′ₜ) is presented as the region of three nearest pixels of pixel xₜ; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ)) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 32

The thirty-second embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated

(2) One pixel xₜ in the space to be evaluated Wₜ is corresponding to x′ₜ in the new space to be evaluated W′ₜ. Assuming the corresponding processing unit A_{proc}(x′ₜ) is presented as the region of four nearest pixels of pixel xₜ; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ)) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 33

The thirty-third embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₜ in the space to be evaluated Wₜ is corresponding to x′ₜ in the new space to be evaluated W′ₜ. Assuming the corresponding processing unit A_{proc}(x′ₜ) is presented as the region of three nearest pixels of pixel xₜ and their center points; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 34

The thirty-fourth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₜ in the space to be evaluated Wₜ is corresponding to x′ₜ in the new space to be evaluated W′ₜ. Assuming the corresponding processing unit A_{proc}(x′ₜ) is presented as the region of four nearest pixels of pixel xₜ and their center points; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ)) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 35

The thirty-fifth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₜ in the space to be evaluated Wₜ is corresponding to x′ₜ in the new space to be evaluated W′ₜ. Assuming the corresponding processing unit A_{proc}(x′ₜ) is presented as within unit length to pixel xₜ; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ)) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 36

The thirty-sixth embodiment of the patent relates to a digital image quality evaluation method. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality of digital images in the space to be evaluated is calculated as follows:

(1) The space to be evaluated Wₜ and the reference space Wᵣₑₚ can be represented by affine transformation. To make sure that each pixel in the space to be evaluated Wₜ has corresponding pixel in the reference space Wᵣₑₚ, up-sampling and down-sampling can be operated if it is necessary, after which reference space Wᵣₑₚ is converted to new reference space W′ᵣₑₚ to present images and space to be evaluated Wₜ is converted to new space to be evaluated W′ₜ;

(2) One pixel xₜ in the space to be evaluated Wₜ is corresponding to x′ₜ in the new space to be evaluated W′ₜ. Assuming the corresponding processing unit A_{proc}(x′ₜ) is presented as within unit length to pixel xₜ and its center point; Mapping this region onto the spherical observation space whose radius is R, the area covered on sphere is S(A_{proc}(x′ₜ)).

(3) In the space to be evaluated, the ratio of area of S(A_{proc}(x′ₜ)) of current processing unit A_{proc}(x′ₜ) corresponding to xₜ in the observation space Wₒ: E_{proc}(A_{proc}(x′ₜ)).

E_{proc}(A_{proc}(x′ₜ)) is relate to the location of S(A_{proc}(x′ₜ)) in the observation space Wₒ, which is not a constant;

(4) The quality Q of x′ₜ in the new space to be evaluated W′ₜ, which is corresponding to x′ₒ in the new reference space W′ᵣₑₚ:

[symbol] (x′ₜ)=c·Eₒᵣᵢ(Aₒᵣᵢ(x′ₒ))·|pₜ(x′ₜ)−pₒ(x′ₒ)|, where c is constant (can be set as 1)_{∘} pₜ(x′ₜ) represents the value of pixel at x′ₜ in the new space to be evaluated, pₜ(x′ₒ) represents the value of pixel at x′ₒ in the new reference space;

(5) The quality of the entire image is presented as

$$Quality = {\sum }_{{x}_{t}^{′} ∈ {W}_{t}^{′}} Q ( {x}_{t}^{′} )$$

### Embodiment 37

The thirty-seventh embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region surrounded by three nearest processing units of current processing unit is marked as B_{proc}. Mapping this region into observation space, the area is S(B_{proc}). And the ratio of this mapping area on whole sphere is E_{proc}(A_{proc})=S(B_{proc})/whole area on observation space. The distortion value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 38

The thirty-eighth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region surrounded by three nearest processing units of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 39

The thirty-ninth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region surrounded by four nearest processing units of current processing unit is marked as B_{proc}. Mapping this region into observation space, the area is S(B_{proc}). And the ratio of this mapping area on whole sphere is E_{proc}(A_{proc})=S(B_{proc})/whole area on observation)) space. The distortion value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 40

The fortieth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ and obtain the distortion value D_{proc}(Aₒᵣᵢ, A′_{proc}) in current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region surrounded by four nearest processing units of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 41

The forty-first embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region surrounded by three nearest processing units and the center point of current processing unit is marked as B_{proc}. Mapping this region into observation space, the area is S(B_{proc}). And the ratio of this mapping area on whole sphere is E_{proc}(A_{proc})=S(B_{proc})/whole area on observation space. The distortion value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 42

The forty-second embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region surrounded by three nearest processing units and the center point of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 43

The forty-third embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region surrounded by four nearest processing units and the center point of current processing unit is marked as B_{proc}. Mapping this region into observation space, the area is S(B_{proc}). And the ratio of this mapping area on whole sphere is E_{proc}(A_{proc})=S(B_{proc})/whole area on observation space. The distortion value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 44

The forty-fourth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ and obtain the distortion value D_{proc}(Aₒᵣᵢ, A′_{proc}) current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region surrounded by four nearest processing units and the center point of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 45

The forty-fifth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ, to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region within unit length of current processing unit is marked as B_{proc}. Mapping this region into observation space, the area is S(B_{proc}). And the ratio of this mapping area on whole sphere is E_{proc}(A_{proc})=S(B_{proc})/whole area on observation space. The distortion)) value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 46

The forty-sixth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region within unit length of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 47

The forty-seventh embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit A_{proc} in the space to be evaluated Wₜ to the observation space, the ratio of area S(A_{proc}) in current processing unit A_{proc} of space to be evaluated to observation space Wₒ can be presented as E_{proc}(A_{proc}), and E_{proc}(A_{proc}) is relate to the location of S(A_{proc}) in the observation space Wₒ, which is not a constant;
(3) The region covered within unit length of current processing unit and center point of current processing unit is marked as B_{proc}. Mapping this region into observation space, the area is S(B_{proc}). And the ratio of this mapping area on whole sphere is E_{proc}(A_{proc})=S(B_{proc})/whole area on observation space. The distortion value is multiplied by this ratio E_{proc}(A_{proc}).
(4) Quality evaluation module, using the processed distortion D_{proc}(Aₒᵣᵢ, A′_{proc}) of current processing unit A_{proc} in the whole space to be evaluated and the corresponding weights E_{proc}(A_{proc}) of pixel group to evaluate the quality of digital images in the space to be evaluated. The final quality of digital image in observation space is:

$$Quality = {\sum }_{{A}_{ori} ∈ {W}_{o}^{′} , {A}_{proc} ∈ {W}_{t}} c \cdot {E}_{proc} ( {A}_{proc} ) \cdot {D}_{proc} ( {A}_{ori} , {A}_{proc}^{′} )$$

And c is a constant, which can be 1.

### Embodiment 48

The forty-eighth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. The combination of Wₜ, Wₒ and Wᵣₑₚ can be (ERP, sphere, ERP), (CMP, sphere, ERP), (ERP, sphere, CMP), (CMP, sphere, CMP), (rectangular pyramid, sphere, ERP), (ERP, sphere, rectangular pyramid), (rectangular pyramid, sphere, rectangular pyramid), (N-face format, sphere, M-face format), (ERP, sphere, M-face format) and (M-face format, sphere, ERP). But combinations are not limited to the above examples. The objective quality module of digital images in the space to be evaluated is described as follows:
(1) Distortion generation module, convert current processing unit A_{proc} in the space to be evaluated Wₜ to the new space to be evaluated W′ₜ, which is the same as reference space Wᵣₑₚ. Calculate the difference of pixels in pixel group of digital images between the current processing unit A′_{proc} in converted space to be evaluated and the current processing unit Aₒᵣᵢ in reference space Wᵣₑₚ, and obtain the distortion value D_{proc}(Aₒᵣᵢ, A′_{proc}) in current processing unit A_{proc} by summing the absolute value of differences.
(2) Weighted distortion processing module, map the current processing unit Aₒᵣᵢ in reference space Wᵣₑₚ to the observation space, the ratio of area S(Aₒᵣᵢ) in current processing unit Aₒᵣᵢ of reference space to observation space Wₒ can be presented as Eₒᵣᵢ(Aₒᵣᵢ), and Eₒᵣᵢ(Aₒᵣᵢ) is relate to the location of S(Aₒᵣᵢ) in the observation space Wₒ, which is not a constant;
(3) The region covered within unit length of current processing unit and center point of current processing unit is marked as Bₒᵣᵢ. Mapping this region into observation space, the area is S(Bₒᵣᵢ). And the ratio of this mapping area on whole sphere is Eₒᵣᵢ(Aₒᵣᵢ)=S(Bₒᵣᵢ)/whole area on observation space. The distortion value is multiplied by this ratio Eₒᵣᵢ(Aₒᵣᵢ).
(4) Quality evaluation module, using the processed distortion D_{proc}(Aₒᵣᵢ, A′_{proc}) of current processing unit Aₒᵣᵢ in the whole space to be evaluated and the corresponding weights Eₒᵣᵢ(Aₒᵣᵢ) of pixel group to evaluate the quality of digital images in the space to be evaluated. The final quality of digital image in observation space is:

$$Quality = {\sum }_{{A}_{ori} ∈ {W}_{o} , {A}_{proc} ∈ {W}_{t}^{′}} c \cdot {E}_{ori} ( {A}_{ori} ) \cdot {D}_{proc} ( {A}_{ori}^{′} , {A}_{proc} )$$

And c is a constant, which can be 1.

### Embodiment 49

The forty-ninth embodiment of the patent relates to a digital image quality evaluation method. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality of digital images in the space to be evaluated is calculated as follows:
(1) According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(2) Determine the weight w(i, j) of each pixel in (i, j) in the space to be evaluated or reference space. The weight for quality evaluation is the stretching ratio SR(x, y) of each pixel. And the stretching ratio SR(x, y) of each pixel using the stretching ratio of center point in (x, y), which can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(3) The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 50

The fiftieth embodiment of the patent relates to a digital image quality evaluation method. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality of digital images in the space to be evaluated is calculated as follows:
(1) According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(2) Determine the weight w(i, j) of each pixel in (i, j) in the space to be evaluated or reference space. The weight for quality evaluation is the stretching ratio SR(x, y) of each pixel. And the stretching ratio SR(x, y) of each pixel using the average stretching ratio of pixel in (x, y), i.e. the region of (w,h): {(w,h)|i−0.5<=w<=i+0.5, j−0.5<=h<=j+0.5}. This can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(3) The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 51

The fifty-first embodiment of the patent relates to a digital image quality evaluation method. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality of digital images in the space to be evaluated is calculated as follows:
(1) According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(2) Determine the weight w(i, j) of each pixel in (i, j) in the space to be evaluated or reference space. The weight for quality evaluation is the normalized stretching ratio SR(x, y) of each pixel so the sum of weights is 1. And the stretching ratio SR(x, y) of each pixel using the stretching ratio of center point in (x, y), which can be obtained according the mapping function between (i, j) and (x, y). It can be derived according to step 1.
(3) The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 52

The fifty-second embodiment of the patent relates to a digital image quality evaluation method. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality of digital images in the space to be evaluated is calculated as follows:
(1) According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(2) Determine the weight w(i, j) of each pixel in (i, j) in the space to be evaluated or reference space. The weight for quality evaluation is the normalized stretching ratio SR(x, y) of each pixel so the sum of weights is 1. And the stretching ratio SR(x, y) of each pixel using the average stretching ratio of pixel in (x, y), i.e. the region of (w,h): {(w,h)|i−0.5<=w<=i+0.5, j−0.5<=h<=j+0.5}. This can be obtained according the mapping function between (i, j) and (X, y). It can be derived according to step 1.
(₃) The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 53

The fifty-third embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality module of digital images in the space to be evaluated is described as follows:
(1) The input of distortion generation module are images in the space to be evaluated and reference space, and output is distortion value. As the space to be evaluated and reference space are the same, the distortion can be directly obtained.
(2) The input of weighted distortion processing module are image format and position, and the output is quality evaluation weights in different position. According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(3) Determine the weight w(i, j) of each pixel in (i, j) in the space to be evaluated or reference space. The weight for quality evaluation is the stretching ratio SR(x, y) of each pixel. And the stretching ratio SR(x, y) of each pixel using the stretching ratio of center point in (x, y), which can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(4) The input of quality evaluation module are distortion values and weights. And output is the results of quality evaluation. The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 54

The fifty-fourth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality module of digital images in the space to be evaluated is described as follows:
(1) The input of distortion generation module are images in the space to be evaluated and reference space, and output is distortion value. As the space to be evaluated and reference space are the same, the distortion can be directly obtained.
(2) The input of weighted distortion processing module are image format and position, and the output is quality evaluation weights in different position. According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(3) Determine the weight w(i, j) of each pixel in (i, j) in the space to be evaluated or reference space. The weight for quality evaluation is the stretching ratio SR(x, y) of each pixel. And the stretching ratio SR(x, y) of each pixel using the average stretching ratio of pixel in (x, y) , i.e. the region of (w,h): {(w,h)|i−0.5<=w<=i+0.5, j−0.5<=h<=j+0.51}. This can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(4) The input of quality evaluation module are distortion values and weights. And output is the results of quality evaluation. The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 55

The fifty-fifth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality module of digital images in the space to be evaluated is described as follows:
(1) The input of distortion generation module are images in the space to be evaluated and reference space, and output is distortion value. As the space to be evaluated and reference space are the same, the distortion can be directly obtained.
(2) The input of weighted distortion processing module are image format and position, and the output is quality evaluation weights in different position. According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(3) Determine the weight w(i, j) of each pixel in (i, j) in the space to be evaluated or reference space. The weight for quality evaluation is the normalized stretching ratio SR(x, y) of each pixel so the sum of weights is 1. And the stretching ratio SR(x, y) of each pixel using the stretching ratio of center point in (x, y), which can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(4) The input of quality evaluation module are distortion values and weights. And output is the results of quality evaluation. The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

### Embodiment 56

The fifty-sixth embodiment of the patent relates to a digital image quality evaluation apparatus. Several basic definitions need to be made. The observation space of digital images is Wₒ. The representation space of digital images is Wₜ and the representation space of reference digital images is Wᵣₑₚ. Wₜ and Wᵣₑₚ are the same, meaning that the images in reference space and the space to be evaluated share same format and resolution. For example, images in Wₜ and Wᵣₑₚ are both ERP or CMP. The observation space is difference from reference space or the space to be evaluated, e.g., sphere. The objective quality module of digital images in the space to be evaluated is described as follows:
(1) The input of distortion generation module are images in the space to be evaluated and reference space, and output is distortion value. As the space to be evaluated and reference space are the same, the distortion can be directly obtained.
(2) The input of weighted distortion processing module are image format and position, and the output is quality evaluation weights in different position. According to the mapping function between reference space or the space to be evaluated and observation space, the stretching ratio SR(x, y) of each position (x, y) in the space to be evaluated or reference space can be obtained. And the stretching ratio SR(x, y) is the ratio of mapping micro area δSᵣₑₚ of (x, y) in observation space to the micro area δS_{t/o} of (x, y) in the space to be evaluated or reference space, i.e., δSᵣₑₚ/δS_{t/o}.
(3) Determine the weight w(i, j) of each pixel in (i, j) in the space to be evaluated or reference space. The weight for quality evaluation is the normalized stretching ratio SR(x, y) of each pixel so the sum of weights is 1. And the stretching ratio SR(x, y) of each pixel using the average stretching ratio of pixel in (x, y), i.e. the region of (w,h): {(w,h)|i−0.5<=w<=i+0.5, j−0.5<=h<=j+0.5}. This can be obtained according the mapping function between (i, j) and (x, y). It can be derived according to step 1. For example, the weights w(i, j) of ERP equal to

$$cos \frac{( j + 0.5 - N \text{/} 2 ) π}{N} ,$$

and N is the height of image, i.e., number of pixels in vertical direction.
(4) The input of quality evaluation module are distortion values and weights. And output is the results of quality evaluation. The objective quality of image with resolution of width*height is calculated as follows:

$$Quality = \frac{1}{{\sum }_{i = 0}^{width - 1} {\sum }_{j = 0}^{height - 1} w ( i , j )} * {\sum }_{i = 0}^{width - 1} {\sum }_{j = 0}^{height - 1} w ( i , j ) * Diff ( i , j )$$

where Diff(i, j) is difference function in (i, j), and difference function can be the sum of the absolute value or mean squared error. The difference function is not limited to the two mentioned above.

It should be noted that the above embodiments are only used to illustrate the technical solutions of the present invention, and are not limited the embodiments; although the present invention has been described in detail with the embodiments, ordinary technicians in this field should understand that the technical solutions described in the foregoing embodiments can be modified, or equivalently substituted on some of the technical features; and the modifications or substitutions do not deviate from the scope of the technical solutions of the embodiments of the present invention.

1. A digital image quality evaluation method for measuring the quality of a digital image to be evaluated in observation space, the method comprising:
summing the absolute value of the pixel values of the respective pixel group of the digital images in the space to be evaluated and the digital images in the reference space pixel by pixel to obtain the distortion values; processing the distortion values of the digital images in the space to be evaluated according to the distribution of pixel groups in observation space; measuring the quality of the digital images in the space to be evaluated by using the distortion value of the pixel groups of the entire digital image to be evaluated after the processing.

2. The method of claim 1, wherein the pixel group comprises at least one of the following expressions:
a) one pixel;
b) one set of spatially continuous pixels in the space;
c) one set of temporally discontinuous pixels in the space.

3. The method of claim 1, wherein the method to obtain the absolute value comprises at least one of the following processing methods:
a) converting the digital image in the space to be evaluated into the same space as the reference space, after calculating each difference of each pixel value between the corresponding pixel in the pixel group of the digital image in the space to be evaluated and the corresponding pixel in the pixel group of the digital image in the reference space, summing the absolute value of differences calculated before;
b) converting the digital image in the reference space into the same space as the space to be converted, after calculating each difference of each pixel value between the corresponding pixel in the pixel group of the digital image in the converted reference space and the corresponding pixel in the pixel group of the digital image in the space to be evaluated, summing the absolute value of differences calculated before;
c) converting the digital image in the reference space and the digital image in the space to be evaluated into the same space which is different from the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;
d) in the case where the space to be evaluated is exactly same as the reference space, conversion is not necessary, after calculating each difference between the corresponding pixel value of the pixel group of the digital image in the space to be evaluated and the corresponding pixel value of the pixel group of the digital image in the reference space, summing the absolute value of differences calculated before.

4. The method of claim 1, wherein the method to process the distortion value of the digital images in the space to be evaluated according to the distribution of the pixel groups in observation space comprises at least one of the following processing methods:
a) projecting the relevant area corresponding to the pixel group of digital image in the space to be evaluated into the observation space and calculate the ratio of the corresponding area to the total area of the image in the observation space; calculating the result by multiplying the ratio and the distortion value;
b) projecting the relevant area corresponding to the pixel group of digital image in the space to be evaluated into the observation space corresponding to the pixel group of digital image in the reference space into the observation space and calculate the ratio of the corresponding area to the total area of the image in the observation space; calculating the result by multiplying the ratio and the distortion value.

5. The method of claim 4, wherein the method to locate the relevant area corresponding to the pixel group comprises at least one of the following methods:
a) taking the area of three nearest pixel groups of this pixel group;
b) taking the area of four nearest pixel groups of the pixel group;
c) taking the area enclosed by three nearest pixel groups of the pixel group and the midpoints of these pixel groups;
d) taking the area enclosed by four nearest pixel groups of the pixel group and the midpoints of these pixel groups;
e) taking the area enclosed by the pixel group on each axis that does not exceed the unit distance between the pixels and the pixel group;
f) taking the area enclosed by the midpoint of the pixel group and the pixel group on each axis that does not exceed the unit distance between the pixels and the pixel group;
g) when the pixel group is one pixel, taking the area determined by the micro unit at the center point of the pixel.

6. A digital image quality evaluation apparatus comprising:
a distortion generation module to sum the absolute value of the pixel values of each pixel group of the digital image in the space to be evaluated and the digital image in the reference space pixel by pixel to obtain the distortion value; the input is the reference spatial digital image and the space to be evaluated and the output is distortion corresponding to the pixel group in the space to be evaluated;
a weighted distortion processing module to process the distortion value according to the distribution of the pixel group of the digital image in the space to be evaluated on the observation space, the input of which is the space to be evaluated and the output is the corresponding weights of the pixel group in the space to be evaluated;
a quality evaluation module that uses the processed distortion corresponding to the pixel group of the digital image of the entire image to be evaluated and the corresponding weights of the digital image to evaluate the quality of the digital image to be evaluated; the input is the corresponding weights of the pixel group and the distortion value corresponding to the pixel group in the space to be evaluated, and the output is the quality of the digital image in the observation space.

7. The apparatus of claim 6, wherein the pixel group comprises at least one of the following expressions:
a) one pixel;
b) one set of spatially continuous pixels in the space;
c) one set of temporally discontinuous pixels in the space.

8. The apparatus of claim 6, wherein the method to obtain the absolute value of the pixel values comprises at least one of the following processing methods:
a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;
b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;
c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;
d) in the case where the space to be evaluated is exactly same as the reference space, conversion is not necessary, after calculating each difference between the corresponding pixel value of the pixel group of the digital image in the space to be evaluated and the corresponding pixel value of the pixel group of the digital image in the reference space, summing the absolute value of differences calculated before.

9. The apparatus of claim 6, wherein the module to process the distortion value according to the distribution in the observation space of the pixel group of the digital image in the space to be evaluated comprises at least one of the following processing methods:
a) projecting the relevant area corresponding to the pixel group of digital image in the space to be evaluated into the observation space and calculate the ratio of the corresponding area to the total area of the image in the observation space; calculating the result by multiplying the ratio and the distortion value;
b) projecting the relevant area corresponding to the pixel group of digital image in the space to be evaluated into the observation space corresponding to the pixel group of digital image in the reference space into the observation space and calculate the ratio of the corresponding area to the total area of the image in the observation space; calculating the result by multiplying the ratio and the distortion value.

10. The apparatus of claim 9, wherein the method to locate the relevant area corresponding to the pixel group comprises at least one of the following methods:
a) taking the area of three nearest pixel groups of this pixel group;
b) taking the area of four nearest pixel groups of the pixel group;
c) taking the area enclosed by three nearest pixel groups of the pixel group and the midpoints of these pixel groups;
d) taking the area enclosed by four nearest pixel groups of the pixel group and the midpoints of these pixel groups;
e) taking the area enclosed by the pixel group on each axis that does not exceed the unit distance between the pixels and the pixel group;
f) taking the area enclosed by the midpoint of the pixel group and the pixel group on each axis that does not exceed the unit distance between the pixels and the pixel group;
g) when the pixel group is one pixel, taking the area determined by the micro unit at the center point of the pixel.

11. A digital image quality evaluation method for measuring the quality of a digital image to be evaluated in observation space of a digital image to be evaluated, the method comprising:
obtaining the distortion values of each pixel group in the digital image by using the pixel values of the respective pixel groups of the digital images in the space to be evaluated and reference space; processing the distortion values of the pixel groups of the digital images in the space to be evaluated according to the distribution in observation space; measuring the quality of the digital images in the space to be evaluated by using the distortion value of the pixel group of the entire digital image to be evaluated after the processing.

12. The method of claim 11, wherein the method to obtain the distortion values of each pixel group in the digital image comprises at least one of the following processing methods:
a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;
b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;
c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;
d) in the case where the space to be evaluated is exactly the same as the reference space, conversion is not necessary; after calculating each difference between the corresponding pixel value of the pixel group of the digital image in the space to be evaluated and the corresponding pixel value of the pixel group of the digital image in the reference space, summing the absolute value of differences calculated before.

13. The method of claim 11, wherein the method to process the distortion values of the pixel groups of the digital images in the space to be evaluated according to the distribution in observation space comprises at least one of the following processing methods:
a) projecting the relevant area corresponding to the pixel group of digital image in the space to be evaluated into the observation space and calculate the ratio of the corresponding area to the total area of the image in the observation space; calculating the result by multiplying the ratio and the distortion value, the result is the processed distortion value;
b) projecting the relevant area corresponding to the pixel group of digital image in the space to be evaluated into the observation space and calculate the stretching ratio of the pixel group of digital image in the space to be evaluated; calculating the result by multiplying the stretching ratio and the distortion value, the result is the processed distortion value.

14. The method of claim 13, wherein the method to locate the relevant area corresponding to the pixel group comprises at least one of the following methods:
a) taking the area of three nearest pixel groups of this pixel group;
b) taking the area of four nearest pixel groups of the pixel group;
c) taking the area enclosed by three nearest pixel groups of the pixel group and the midpoints of these pixel groups;
d) taking the area enclosed by four nearest pixel groups of the pixel group and the midpoints of these pixel groups;
e) taking the area enclosed by the pixel group on each axis that does not exceed the unit distance between the pixels and the pixel group;
f) taking the area enclosed by the midpoint of the pixel group and the pixel group on each axis that does not exceed the unit distance between the pixels and the pixel group;
g) when the pixel group is one pixel, taking the area determined by the micro unit at the center point of the pixel.

15. A digital image quality evaluation apparatus comprising:
a distortion generation module to obtain the distortion value of the pixel values of each pixel group in the digital image to be evaluated pixel by pixel with the corresponding pixel values of the digital image in the reference space; the input is the digital images in reference space and the space to be evaluated and the output is distortion values for the pixel group in the space to be evaluated;
a weighted distortion processing module to process the distortion value of the pixel group of the digital image in the space to be evaluated according to the distribution in the observation space, the input of which are the distribution of pixel group in the digital image to be evaluated and the observation space, and the output is the corresponding weights of the pixel group in the space to be evaluated;
a quality evaluation module that uses the processed distortion corresponding to the pixel group of the digital image of the entire image to be evaluated and the corresponding weights of the digital image are utilized to measure the quality of the digital image to be evaluated; the input is the corresponding weights of the pixel group and the distortion values corresponding to the pixel group in the space to be evaluated, and the output is the quality of the digital image in the observation space.

16. The apparatus of claim 15, wherein the method to obtain the distortion value of the pixel values comprises at least one of the following processing methods:
a) converting the digital image in the space to be evaluated into the same space as the reference space, after calculating each difference between the corresponding pixel value of the pixel group of the digital image in the space to be evaluated and the corresponding pixel value of the pixel group of the digital image in the reference space, summing the absolute value of differences calculated before;
b) converting the digital image in the reference space into the same space as the space to be converted, after calculating each difference between the corresponding pixel value of the pixel group of the digital image in the converted reference space and the corresponding pixel value of the pixel group of the digital image in the space to be evaluated, summing the absolute value of differences calculated before;
c) converting the digital image in the reference space and the digital image in the space to be evaluated into the same space which is different with the observation space, after calculating each difference between the corresponding pixel value of the pixel group of the digital image in the converted reference space and the corresponding pixel value of the pixel group of the digital image in the space to be evaluated after conversion, summing the absolute value of differences calculated before;
d) in the case where the space to be evaluated is exactly same as the reference space, conversion is not necessary, after calculating each difference between the corresponding pixel value of the pixel group of the digital image in the space to be evaluated and the corresponding pixel value of the pixel group of the digital image in the reference space, summing the absolute value of differences calculated before.

17. The apparatus of claim 15, wherein the module to process the distortion value of the pixel group of the digital image in the space to be evaluated according to the distribution in the observation space comprises at least one of the following processing methods:
a) projecting the relevant area corresponding to the pixel group of digital image in the space to be evaluated into the observation space and calculate the ratio of the corresponding area to the total area of the image in the observation space; calculating the result by multiplying the ratio and the distortion value, the result is the processed distortion value;
b) projecting the relevant area corresponding to the pixel group of digital image in the space to be evaluated into the observation space and calculate the stretching ratio of the pixel group of digital image in the space to be evaluated; calculating the result by multiplying the stretching ratio and the distortion value, the result is the processed distortion value.

18. The apparatus of claim 17, wherein the method to locate the relevant area corresponding to the pixel group comprises at least one of the following methods:
a) taking the area of three nearest pixel groups of this pixel group;
b) taking the area of four nearest pixel groups of the pixel group;
c) taking the area enclosed by three nearest pixel groups of the pixel group and the midpoints of these pixel groups;
d) taking the area enclosed by four nearest pixel groups of the pixel group and the midpoints of these pixel groups;
e) taking the area enclosed by the pixel group on each axis that does not exceed the unit distance between the pixels and the pixel group;
f) taking the area enclosed by the midpoint of the pixel group and the pixel group on each axis that does not exceed the unit distance between the pixels and the pixel group;
g) when the pixel group is one pixel, taking the area determined by the micro unit at the center point of the pixel.
